(19) United States
(12) Patent Application Publication
(10) Pub. No.: US 2015/0264148 A1
(43) Pub. Date: Sep. 17, 2015

(54) CONNECTION OF PERSONS AND THINGS VIA MOBILE MESSAGING PRIVACY/SECURITY BROKER SYSTEM

(71) Applicant: Avaya Inc., Santa Clara, CA (US)

(72) Inventors: David Skiba, Golden, CO (US); Andrew Maher, Wiesbaden (DE); George Erhart, Loveland, CO (US); Valentine C. Matula, Granville, OH (US)

(21) Appl. No.: 14/513,362

(22) Filed: Oct. 14, 2014

Related U.S. Application Data
(60) Provisional application No. 61/952,641, filed on Mar. 13, 2014.

(51) Int. Cl. H04L 29/08

(52) U.S. Cl. CPC H04L 67/288; H04L 67/141

(57) ABSTRACT

Contact centers often have a significant pool of troubleshooting information related to devices that a customer may own or have access to. Connecting the device to a resource of the contact center presents challenges as customers and device manufacturers are reluctant to provide direct connectivity from the device to a public network, such as the Internet. A customer communication device, such as a smart phone, with an application allows a user to broker a communication between a resource of a contact center and a device. As a benefit, the customer can see and control the types of communication occurring and approve or deny according to their comfort level. When the resource-device session is concluded, the link is terminated and cannot be resumed without again obtaining approval.

### CROSS-REFERENCE TO RELATED APPLICATION

The present application claims the benefit of Provisional Patent Application No. 61/952,641, filed on Mar. 13, 2014, and is incorporated herein by reference in its entirety.

### FIELD OF THE DISCLOSURE

The present disclosure is generally directed toward communications between a device and a contact center.

### BACKGROUND

The number and types of devices that are becoming “connected devices” continue to increase. Connected devices are able to communicate with the owner, user, or other party utilizing a communication medium, such as a message exchange service, to communicate with the device and provide additional services. For example, a household appliance may send a message to indicate a component's erratic behavior before the component fails. The user may then call a service center with the error code. The service center may then dispatch a service technician to replace the failed or failing component.

Having the ability to access and control these connected devices has many advantages, and some potentially serious disadvantages. Connected devices, like all devices having access to public networks (e.g., the Internet) are always at risk for malware or other attacks. Device manufacturers and customers may be reluctant to make or use connectivity features if the risk is perceived as too great for the benefit provided. For example, a customer may not purchase a connected refrigerator, disable, or not enable the connectivity feature, if the real or apparent threat of a hacker is outweighed by the advantage of prompt notification of a failure that may not occur for many years. This is especially true if the security features require updating. The pool of customers willing to apply periodic updates to their refrigerator's anti-virus software is likely to be limited. The consequences for not applying the updates may be an exploitable vulnerability that may be substantial in light of the potential benefits.

Customers who feel the advantages do not outweigh the risk and be more likely to continue to purchase non-connected devices or disable the connectivity of connected devices. If an issue arises they will, as before, call a service center. The service center may ask customers to perform certain operations so that the issue may be isolated or verified. However, many customers may find the requested operations difficult or undesirable. A service technician may have little information prior to beginning service and if a replacement part is needed, the device may be disabled for additional time as a replacement part is retrieved.

Continuing the example, a problematic refrigerator may be connectable to the Internet to allow a service center to access the information. However, if a refrigerator full of food is starting to spoil, a customer is unlikely to want to spend time configuring their router to allow a service center to have access to the device. Even if access to the public network were to be granted to a service center, customers may still feel uneasy and suspect they left a “back door” open to their network, whether or not they actually did.

### SUMMARY

It is with respect to the above issues and other problems that the embodiments presented herein were contemplated.

In one embodiment, a mechanism is disclosed wherein a mobile message application with multi-modal communication capabilities works as a proxy/broker for a contact center, enterprise, or related to access to a customer's “internet of things” connected devices. One advantage provided herein is a central control point providing improved privacy and security. On the other end of the communication is a contact center that is provided with a means to access more information from more devices, in part, due to customer acceptance to grant such access afforded by the increased connectivity control offered to the customer. A personal context layer, is also provided, such as when brokering connections to publicly deployed “internet of things.”

In one embodiment, a detection-communication module is provided. The module may be operated within or by a user's mobile device, such as a component of an installed application. The detection-communication module searches for “internet of things” within proximity of the user. Detection of any “internet of things” device may be through any enabled communication or detection method available on a mobile device (e.g., Wi-Fi, Bluetooth, infrared, or any other communication medium between devices). The types of “things” that may qualify as devices within the “internet of things” realm include, but are not limited to, personally owned devices (e.g., television, refrigerator, garage door opener, automobile, etc.); authorized things (e.g., work printer, work laptop, rental car, etc.), and public things (e.g., parking meter, check-in kiosk, etc.). The scanning for devices may be continuous, automatic (e.g., upon receiving a signal from another sensor, such as GPS, etc.) or manually activated, such as when a user is, or is about to, communicate with a contact center or seeks to connect to a device.

A communication-initiating event occurs between a user and the contact center which utilizes a social mobile real time application, which may incorporate and/or access connected device communication application. The event could be initiated by the user contacting the company via a company contact center, the contact center contacting the user, or the user contacting a proximate “thing” (e.g., accessible device).

In the course of user-company conversation, interaction, support activity, or service acquisition it may becomes advantageous for the company to interact with the proximate “thing.” Accordingly, access is then initiated.

Access to the “thing” is not allowed directly. Instead the contact center must be authorized by the user and the flow of information is managed by user's mobile device, utilizing the social mobile real time application for data communication. For example, the user may provide or be provided status checks, log files, upgrades selection, service purchase options, etc. Once complete, the company's connection with the “thing” is revoked and any subsequent request for access must go through a reauthorization process.

In one example, a user has a refrigerator with a Bluetooth enabled connection. The refrigerator has been having, what appears to be, random outages with the freezer. The user contacts customer support and texts the basic problem to the agent. The agent has the user use an application on their smart phone to authorize a temporary service connection. The agent then has access, through the social mobile real time application, to begin accessing on refrigerator data. The user is able to see the inquiries and results as the agent gathers the model information and downloads logs for the past few weeks. The conversation then continues with the user who answers some of the agent's questions. The customer support agent determines that a freezer component is failing. The agent gets the part number and creates an order for a replacement part. The customer is then able to deauthorize the connection and the agent schedules a service call incorporating the information gathered from the interaction and the user's location. The interaction was simple and the agent/support center was not provided with access to the user's private network and without a complex setup process otherwise required to connect the refrigerator to the public network.

In another example, a user loses the keys to their rental car. The user contacts the rental car company who then brings in an expert from the auto manufacturer. They utilize the social mobile real time application to address the current problem. The application has authentication built in as well as other channels for extended validation (e.g., voice, video). The user is authenticated as the renter of the automobile. The auto manufacturer requests access to the auto through the user's mobile device. The user accepts and the auto agent activities are displayed to all parties on the conversation. The auto manufacturer connects and is able to unlock/start the vehicle. All groups have a record of the transaction. The rental agent then sends location/directions to get the user to the nearest location for a vehicle exchange. The interaction with the auto was managed by the user's mobile device operating as a proxy device and providing an acceptable level of security for all parties. A direct connection between the agent and manufacturer to the auto was not required, but instead a managed connection was established through the user and user's mobile device.

As used herein, the “thing” refers to accessible device. The term “accessible device” as used herein, means a device comprising logic and a communication interface to enable the accessible device to be placed in communication with another distinct electronic device, such as a mobile communication device (e.g., smart phone, laptop, tablet computer, etc.).

In one embodiment, a mobile communication device is disclosed, comprising: a first communication interface; a second communication interface; a third communication interface; a user interface; and a control module; and wherein the first communication interface is operable to connect the mobile communication device to a resource of a contact center; wherein the second communication interface is operable to connect the mobile communication device to a first accessible device; and wherein the third communication interface comprises at least a portion of the first and second communication interfaces and is operable to broker a communication between the resource to the first accessible device, and wherein the communication is gated by the control module.

In another embodiment, a non-transitory computer readable medium with instructions thereon is disclosed that when read by a computer cause the computer to perform: establishing a first communication with a resource of a contact center; establishing a second communication with a first accessible device, wherein the second communication comprises a wireless communication; brokering a third communication, comprising a first number of communication types, between the resource and the first accessible device; and gating the first number of communication types.

In yet another embodiment, an electronic communication system is disclosed, comprising: a contact center comprising a resource and operable to place the resource and a customer in communication with each other over an electronic network and wherein the customer communicates with the agent using a customer communication device; the resource, being configured to communicate with an accessible device via the customer communication device; and wherein the communication between the resource and the accessible device is gated by a control module of the customer communication device.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first view of communication system in accordance with embodiments of the present disclosure;

FIG. 2 depicts a second view of a communication system in accordance with at least some embodiments of the present disclosure;

FIG. 3 depicts a third view of a communication system in accordance with at least some embodiments of the present disclosure;

FIG. 4 depicts a mobile communication device in accordance with at least some embodiments of the present disclosure;

FIG. 5A-5D depict a sequence presented on display of a mobile communication device in accordance with at least some embodiments of the present disclosure; and

FIG. 6 depicts components of a mobile communication device in accordance with at least some embodiments of the present disclosure; and

FIG. 7 depicts a process in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

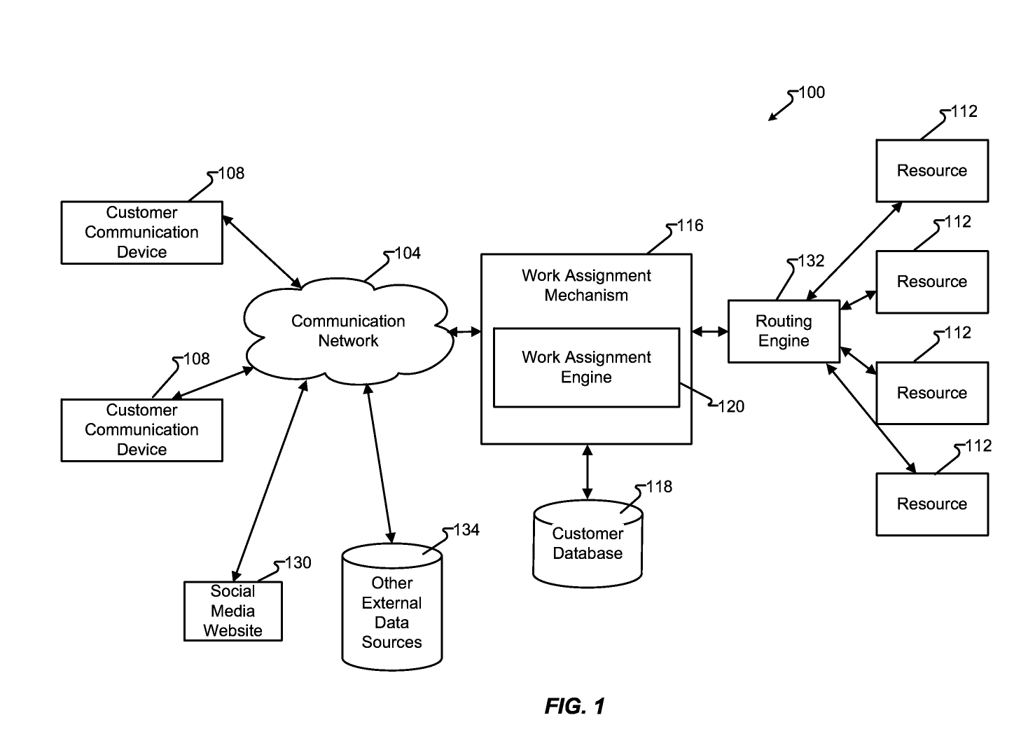

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 and/or other external data sources 134 may be utilized to provide one means for a resource 112 to receive and/or retrieve contacts and connect to a customer of a contact center. Other external data sources 134 may include data sources such as service bureaus, third-party data providers (e.g., credit agencies, public and/or private records, etc.). Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to the contact center. Customer database 118 may be updated in response to a work item and/or input from resource 112 processing the work item.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

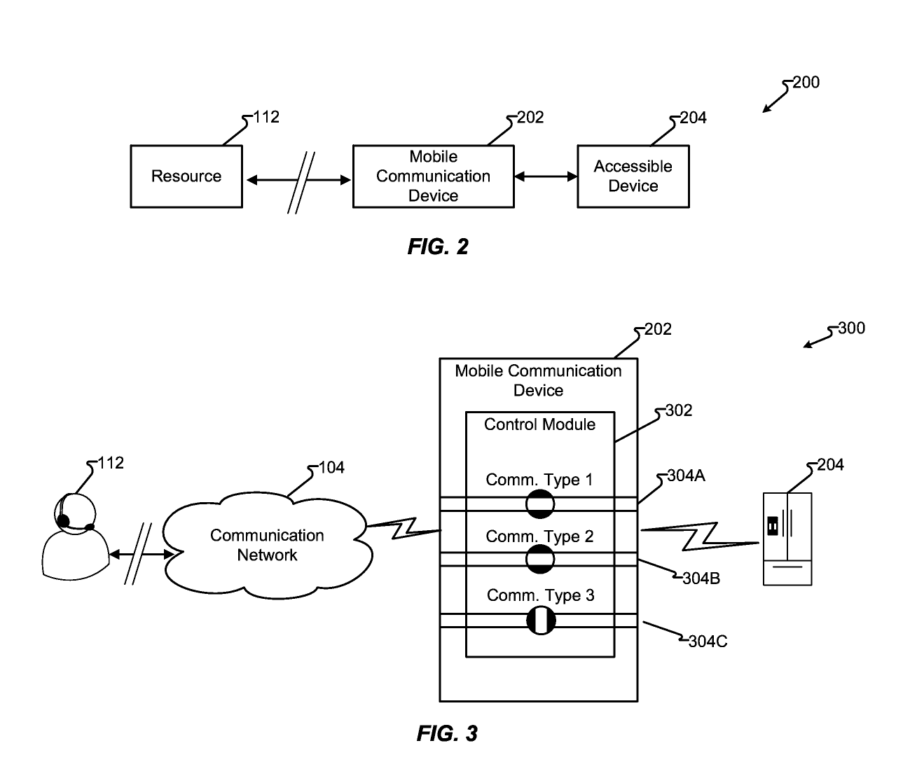

With reference now to FIG. 2, illustrative communication system 200 is discussed in accordance with at least some embodiments of the present disclosure. Mobile communication device 202 comprises customer communication device 108 enabling communication between mobile communication device 202 and resource 112 of a contact center. In addition, mobile communication device 202 is operable to communicate with accessible device 204. Certain components utilized in the facilitation of the communication between mobile communication device 108 and resource 112 are omitted for the avoidance of unnecessarily complicating the figure. A more complete discussion of the communication components, including those omitted from FIG. 2, are provided with respect to FIG. 1 and the discussion thereof.

In one embodiment, communication between resource 112 and accessible device 204 is provided via mobile communication device 202, such as by an application running thereon. In another embodiment, mobile communication device 202 connects to accessible device 204 in a more secure manner, as compared to enabling accessible device to communicate via the Internet. Mobile communication device and accessible device may communicate via near field radio, infrared, Bluetooth, or other proximity-required communication. As an advantage of utilizing proximity-required communication, a “hacker” or other malicious agent would be unable to gain access to accessible device 204 unless physically proximate (e.g., within near field radio, Bluetooth, and/or infrared communication range).

While certain advantages may be realized with the communication between mobile communication device 202 and accessible device 204 being a wireless communication, such as the ability for mobile communication device 202 to be a user's cellular telephone without requiring any additional hardware, in certain embodiments, the connection may be wired without departing from the disclosure provided herein. The communication between resource 112 and mobile communication 202 may be via private and/or public network (e.g., Intranet, Internet, public switched telephone network, cellular network, etc.) as more fully described with respect to FIG. 1. As a result of certain embodiments disclosed herein resource 112 may communication with accessible device 204 in a manner authorized by a user interfacing with mobile communication device 202.

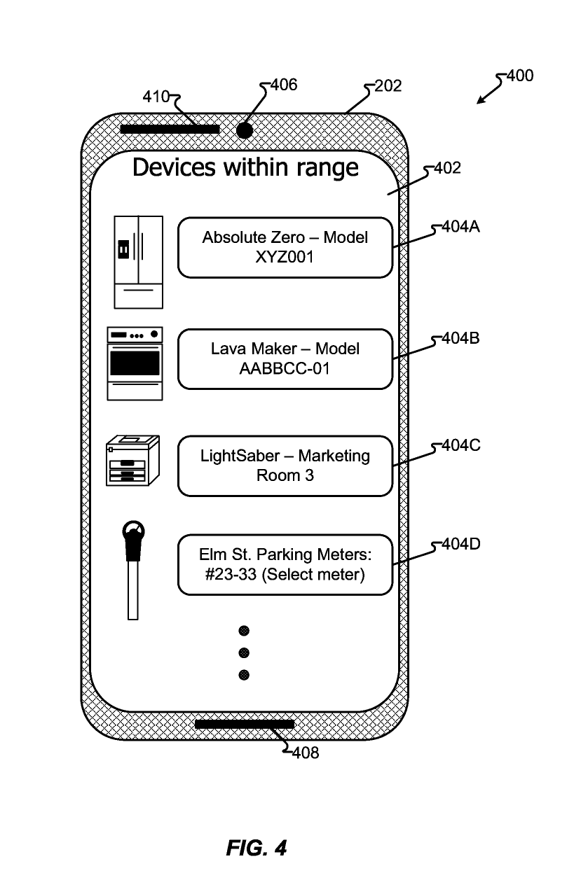

With reference now to FIG. 3, illustrative communication system 300 is discussed in accordance with at least some embodiments of the present disclosure. Resource 112, such as a human and/or automated agent connects themselves, via an application interface, services or other hardware and/or software to communicate with accessible device 204. The communication between resource 112 and accessible device 204 is brokered by communication network 104 and mobile communication device 202. For example, resource 112 may be a human agent who selects various commands for accessible device 204 to execute with resource 112 observing the results. Resource 112 may connect an automatic diagnostic service to accessible device 204 such that an automated testing application may execute commands, retrieve information, and/or observe results.

In one embodiment, mobile communication device 202 comprises control module 302. Control module 302 is operable to broker the communication between resource 112 and accessible device 204 by observing, reporting, and/or controlling (e.g., permit, deny, throttle, etc.) a number of communication types 304. For example, communication type 1 (304A) and communication type 2 (304B) are permitted by control module 302. Communication type 3 (304C) is denied by control module 302. Control module 302 receives control signals from a user input and/or stored values (e.g., default settings, settings from a prior session, etc.).

The components that comprise a communication type are variously embodied. A communication type may be directional (e.g., permit/deny read-only mode, write-only mode, or both read-write mode), action (e.g., permit/deny access to one type of device setting and allow others, permit/deny shutdown/restart), limit (e.g., permit access to modify a freezer temperature 5 degrees, deny access to modify a freezer temperature 20 degrees), and/or temporary (e.g., allow one or more changes made by resource 112 to be undone).

In one embodiment, the communication between resource 112 and mobile communication device 202 is a first communication, the communication between the mobile communication device 202 and accessible device 204 is a second communication, and the communication of resource 112 and accessible device 204, via mobile communication device 202, is a third communication. In one embodiment, the first communication utilizes a first communication interface (e.g., Internet, cellular network, etc.), the second communication utilizes a second communication interface (e.g., WiFi, Bluetooth, infrared, etc.), and the third communication interface utilizes a portion of the first and second communication interfaces.

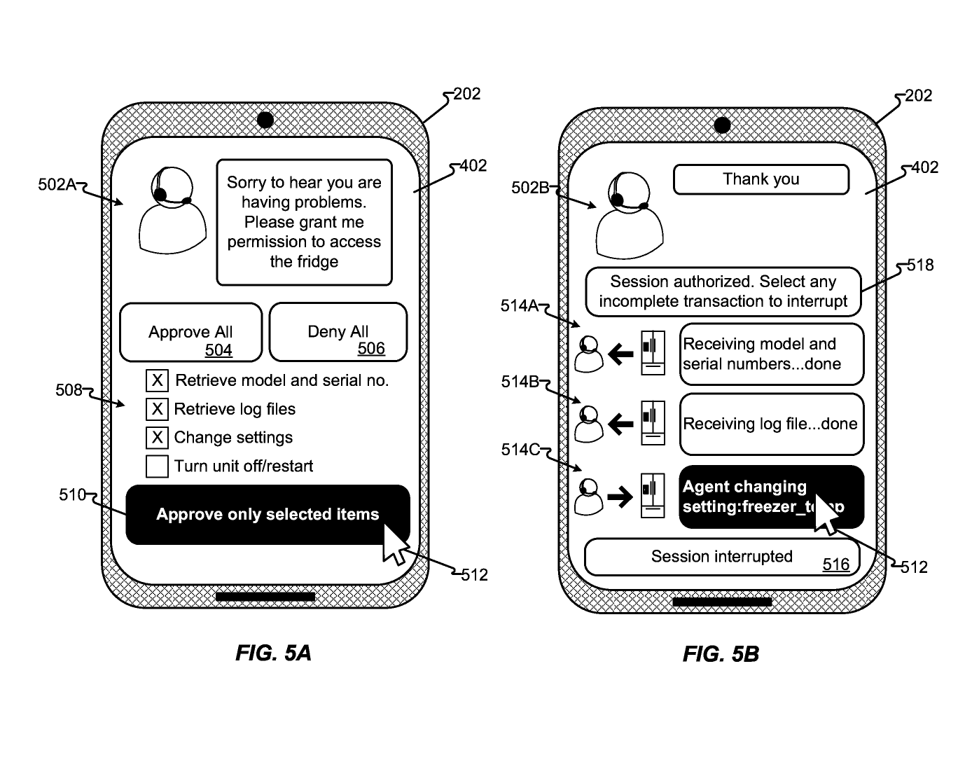

With reference now to FIG. 4, illustrative mobile communication device 202 is discussed in accordance with at least some embodiments of the present disclosure. In one embodiment, mobile communication device 202 comprises an application that, when executed, is operable to display interface 402 and perform message exchange services. Interface 402 displays a number of accessible devices 204 that are within range (i.e., communication therewith is possible). Text and/or graphical representation of accessible devices is provided, such as by text and graphics 404.

In another embodiment, a user operating mobile communication device 202 selects one of accessible device 204, via an associated icon 404, to establish a communication therewith. Icon 404 may be text, graphic, audio cue, video, haptic feedback and/or other indicator that may be understood by a user to be associated with a particular accessible device 204. In another embodiment, the selected accessible device 204 may indicate that it is the device selected, such as by presenting a message, sound, and/or light. The user may have previously established the first communication and is currently engaged in a communication with resource 112 (not shown). For example, mobile communication device 202 may incorporate camera 406, microphone 408, speaker 410 and telephone functionality (not shown) to allow a user to call resource 112 and engage in an audio and/or video call. Additionally mobile communication device 202 may comprise a physical and/or virtual keyboard (not shown) to enable the communication between mobile communication device 202 and resource 112 to be text-based.

As displayed on interface 402, various accessible devices 204 have been detected and are available for interaction. In one embodiment, icon 404A (e.g., a home refrigerator), icon 404B (e.g., a home stove), icon 404C (e.g., a work printer), and icon 404D (e.g., public parking meters) are provided. The embodiment illustrates mobile communication device 202 within an area operable to communicate with private accessible devices (e.g., accessible devices 204 indicated by icons 404A, 404B), authorized accessible devices (e.g., accessible devices 204 indicated by icon 404C), and public accessible devices (e.g., accessible devices 204 indicated by icons 404D). In other deployments, the accessible devices 204 displayed on display 402 will be accessible devices 204 that are then proximate to mobile communication device 202.

In another embodiment, a user selects one icon 404 and mobile communication device 202 established a communication therewith. In another embodiment, two or more icon 404 are selected, such as when the associated accessible devices 204 interact. Icon 404D is associated with a plurality of accessible devices 204 (e.g., a number of parking meters within communication proximity to mobile communication device 202). A user operating mobile communication device 202 may be presented with a second dialog, display, or other presentation providing the user with the opportunity to select a particular parking meter, such as in accord with a number displayed on the physical parking meter at which the user has parked their vehicle. Alternative means for selecting one of a group of accessible devices 204 includes capturing an image (e.g., QR Code) or signal (e.g., audio, visual, and/or radio signal such as may be triggered by the user physically interacting with a particular accessible device 204) when two or more candidate accessible devices 204 may be available.

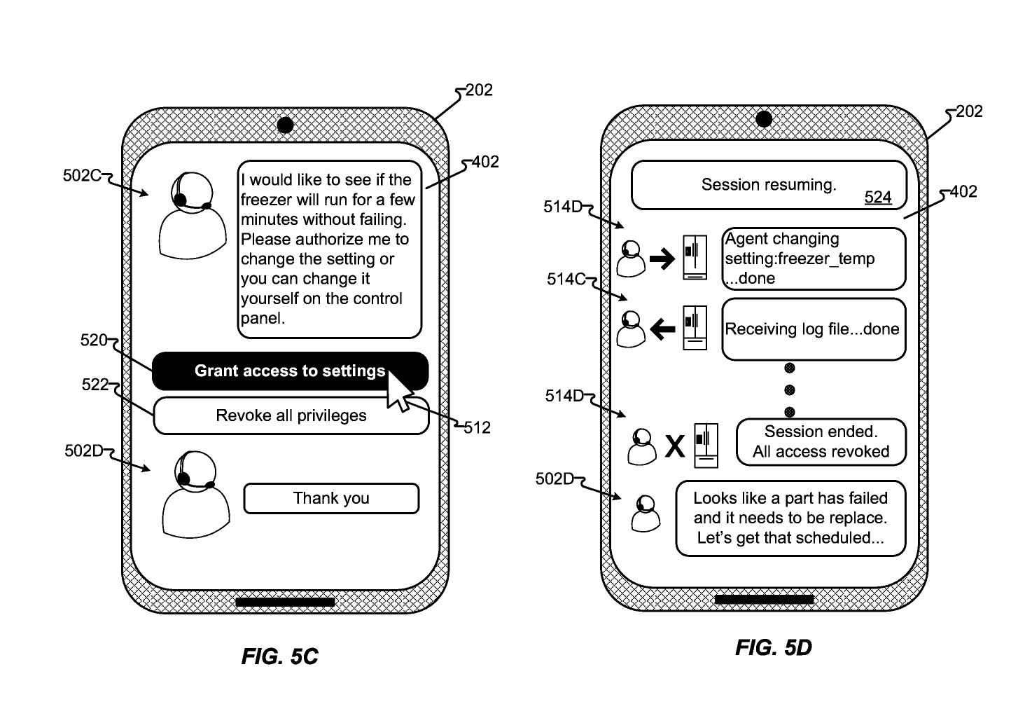

With reference now to FIGS. 5A-5D, an illustrative sequence presented on display 402 of mobile communication device 202 is discussed in accordance with at least some embodiments of the present disclosure. In one embodiment, a user operating mobile communication device 202 first established a communication with accessible device 204 before establishing a communication with resource 112. In another embodiment, a user operating mobile communication device 202 first established a communication with resource 112 before establishing the communication with accessible device 204. It will be appreciated by those of ordinary skill in the art that the text-chat illustrated with respect to FIG. 5 may be, in whole or in part, audio, video, co-browse, or other communication modes, without departing from the disclosure provided herein.

A user operating mobile communication device 202 selects icon 404A (see FIG. 4) associated with accessible device 204 (e.g., the user's household refrigerator). In one embodiment, resource 112 communicates with a user associated with mobile communication device 202 via display 402 and resource-user communications 502 are displayed on display 402. Resource-user communication 502A requests permission to allow the third communication (i.e., between resource 112 and accessible device 204). Display 402 may provide an approve all icon 504, deny all icon 506, and/or communication type specific icon 508. The user has selected those communication types to authorize and indicated the selection by clicking on icon 510 as indicated by pointer 512. Other selecting means (e.g., finger, keyboard, speech recognition, etc.) may be utilized to receive a user's decision as is known in the art of computer-human interfaces.

FIG. 5B illustrates a subsequent sequence. Resource-user communication 502B follows and the session is initiated with control module 302 selectively allowing approved communication types (e.g., retrieval of model and serial number, log files, changing of settings and not turning off or restarting the refrigerator). Third communication between accessible device 204 and resource 112 is established and resource-device events 514 are displayed. Events 514 may be messages of a message exchange service and be general (e.g., “communicating,” “sending,” “receiving,” etc.), machine-level (e.g., “set(memory 00F3)=01”), and/or a custom message format (e.g., “setting target_temp to 34,” “clearing log file,” etc.). The detail level may be set, in part, by the manufacturer of accessible device 204 or configurable by, for example, a user setting on mobile communication device 202, resource 112 setting, application setting, and/or accessible device 204. A user, as indicated by pointer 512, selects resource-device 514C and status 516 indicates that the session has been interrupted. In one embodiment, the third communication between resource 112 and accessible device 204 is paused. In another embodiment, only the specific communication type (e.g., change settings) is interrupted.

FIG. 5C illustrates a subsequent sequence. Resource-user communication 502C is presented, such as the resource explaining to the user the reason for the action associated with the now-paused communication type. In one embodiment, the user may be presented with a grant icon 520 and/or the revoke all privileges icon 522, such as to terminate the resource-device communication. When all communication types are paused, the actions may be limited to resuming and/or re-selecting specific icons 508 to authorize or deny. The user selects icon 502 and resource-user communication 502D is presented with processing continuing.

FIG. 5D illustrates a subsequent sequence. Status icon 524 confirms the session (e.g., the third communication session) has been resumed. Resource-device events 514 are displayed until resource-device event 514D indicates the resource 112 is no longer in communication with accessible device 204. Resource-user communication 502D is presented, such as to inform the user of the recommended events, such as scheduling a service call.

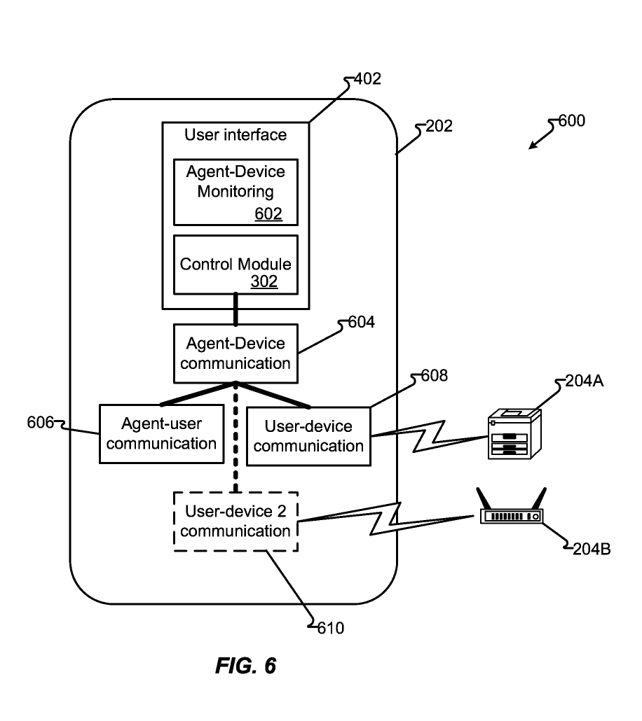

With reference now to FIG. 6, illustrative system 600 is discussed in accordance with at least some embodiments of the present disclosure. In one embodiment, mobile communication device 202 comprise a number of logic modules which may be embodied as hardware, software, or a combination thereof. User interface 402 provides a display for resource-device monitoring 602 to enable a user of mobile communication device 202 to monitor the activities of a resource 112 when communicating with accessible device 204. Control module 302 comprises a display portion presented on user interface 402 and sets permissions in accord with a user input for resource-device communication 602.

Resource-user communication 606 provides a communication interface between mobile communication device 202 and resource 112 of a contact center to enable a first communication. User-device communication 608 provides a communication interface between mobile communication device 202 and accessible device 204 (e.g., 204A) and enables a second. Resource-user communication 606 and user-device communication comprise a portion of resource-device communication 604 and enables a third communication between resource 112 and at least one accessible device 204.

Optionally, user-device second communication 610 enables a fourth communication between mobile communication device 202 and accessible device 204 (e.g., 204B). In another embodiment, a single user-device communication module 208 may enable the second and third communications between accessible device 204A and 204B, respectively. As a benefit, resource 112 may interact with a plurality of accessible devices 204. In one example, a user is unable to get a printer (e.g., accessible device 204A) to work correctly with a router (e.g., accessible device 204B). The settings of the printer alone and the router alone do not reveal the configuration error. Resource 112, in accord with embodiments provided herein, accesses printer 204A and router 204B to determine where the problem lies and apply the appropriate correction to one or both.

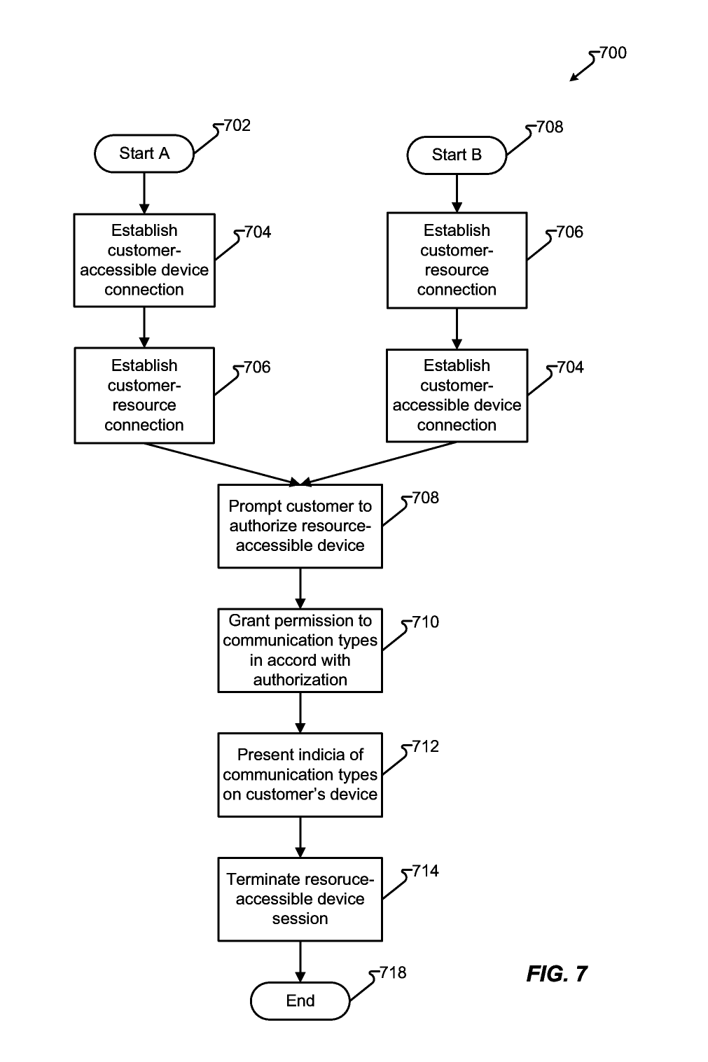

With reference now to FIG. 7, process 700 is discussed in accordance with at least some embodiments of the present disclosure. In one embodiment, process 700 is initiated at start 702. Step 704 establishes a connection between a customer (e.g., via customer communication device 202) and accessible device 204. In one embodiment, step 702 is a short distance communication and may comprise a link via near field radio, optical (e.g., infrared), Bluetooth, etc. Next, step 706 establishes a communication between customer (e.g., via customer communication device 202). In one embodiment, step 706 establishes a connection that comprises, at least in part, a PSTN, cellular, Internet, and/or other public networks. Step 706 may utilize private components in part, such as a Wi-Fi, Intranet, Bluetooth, LAN, WAN, or other non-public component such as to connect to the public portion of the connection.

In another embodiment, process 700 is initiated at start 708 and steps 704 and 706 are reversed from process 700 as initiated from start 702. For example, step 706 is performed and a customer contacts a resource to discuss an issue regarding the accessible device (e.g., using a smart phone to contact customer support to discuss an issue). Step 704 is then performed to establish the connection between the customer and the accessible device. In one embodiment, resource 112 instructs the customer how to launch and application, select an accessible device, and/or connect to the accessible device.

Step 708 displays a prompt on customer communication device 202 to authorize a communication between resource 112 and accessible device 204. Step 710 then authorizes at least one communication type of the resource-accessible device communication in accord with inputs received in response to the prompting of step 708. Step 712 presents indicia of communication types on the user interface of customer communication device 202. Optionally, step 712 allows the customer, via the user interface of customer communication device 202, to interrupt one communication type or the entire communication. An interrupted communication or communication type may then be resumed or terminated in accord with the customer's inputs.

Step 714 terminates the communication session between resource 112 and accessible device 202. Optionally, a summary, log, and/or other records associated with the resource-accessible device is made available to the customer and/or resource 112.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A mobile communication device, comprising:
a first communication interface;
a second communication interface;
a third communication interface;
a user interface; and
a control module; and
wherein the first communication interface is operable to connect the mobile communication device to a resource of a contact center;
wherein the second communication interface is operable to connect the mobile communication device to a first accessible device; and
wherein the third communication interface comprises at least a portion of the first and second communication interfaces and is operable to broker a communication between the resource to the first accessible device, and wherein the communication is gated by the control module.

2. The mobile communication device of claim 1, wherein the communication comprises a first number of communication types.

3. The mobile communication device of claim 2, wherein:
the user interface is operable to display indicia of the first number of communication types and receive an input associated with an authorization decision for at least one of the first number of communication types; and
the user interface is operable to causes the control module to gate the at least one communication type in accord with the input.

4. The mobile communication device of claim 3, wherein:
the control module is further operable to gate the at least one communication type in accord with the input to interrupt the at least one communication type in progress.

5. The mobile communication device of claim 4, wherein:
the control module is further operable to gate the at least one communication type in accord with the input to resume the at least one communication type that has been interrupted.

6. The mobile communication device of claim 2, further comprising a memory operable to store indicia of the first number of communication types for presentation on the user interface.

7. The mobile communication device of claim 1, wherein the first accessible device is located by a scan for accessible devices.

8. The mobile communication device of claim 1, wherein the scan for accessible devices is performed by the mobile communication device in response to a signal from the resource.

9. The mobile communication device of claim 1, wherein the first communication interface is a wired communication interface.

10. The mobile communication device of claim 1, further comprising:
a fourth communication interface;
wherein the fourth communication interface is operable to wirelessly connect the mobile communication device to a second accessible device; and
wherein the third communication interface comprises at least a portion of the first and fourth communication interfaces and is operable to connect the resource to the second accessible device, and wherein the fourth communication interface is gated by the control module in response to inputs received on the user interface.

11. A non-transitory computer readable medium with instructions thereon that when read by a computer cause the computer to perform:
establishing a first communication with a resource of a contact center;
establishing a second communication with a first accessible device, wherein the second communication comprises a wireless communication;
brokering a third communication, comprising a first number of communication types, between the resource and the first accessible device; and
gating the first number of communication types.

12. The non-transitory compute readable medium of claim 11, further comprising instructions to perform the step of gating the first number of communication types in response to receiving a user input associated with at least one of the first number of communication types.

13. The non-transitory compute readable medium of claim 12, further comprising instructions to perform the step of receiving the input and gating the at least one communication type to interrupt the at least one communication type in progress.

14. The non-transitory compute readable medium of claim 13, further comprising instructions to perform the step of receiving the input and gating the at least one communication type to resume the at least one communication type having been previously interrupted.

15. The non-transitory compute readable medium of claim 11, further comprising instructions to perform scanning wireless signals for the accessible device and upon detecting at least one candidate device, presenting the candidate device to a display for selection from a user input, and upon receiving the selection from the user, setting the candidate device to be the accessible device.

16. The non-transitory compute readable medium of claim 11, further comprising instructions to perform establishing a fourth communication with a second accessible device, and the step of brokering further comprises brokering a second number of communication types, between the resource and the second accessible device.

17. An electronic communication system, comprising:
a contact center comprising a resource and operable to place the resource and a customer in communication with each other over an electronic network and wherein the customer communicates with the resource using a customer communication device;
the resource, being configured to communicate with an accessible device via the customer communication device; and
wherein the communication between the resource and the accessible device is gated by a control module of the customer communication device.

18. The electronic communication system of claim 17, wherein the communication between the resource and the accessible device is gated by the customer selectively granting and denying permission for at least one communication type.

19. The electronic communication system of claim 18, wherein the at least one communication type comprises at least one of reading an event log of the accessible device, setting an operating parameter of the accessible device, and shutting down the accessible device.

20. The electronic communication system of claim 18, wherein a display of the customer communication device displays indicia of the at least one communication types.
